(19) United States
(12) Patent Application Publication
(10) Pub. No.: US 2016/0348594 A1
(43) Pub. Date: Dec. 1, 2016

(54) FUEL PURGE SYSTEM AND METHOD OF PURGING

(71) Applicant: General Electric Company, Schenectady, NY (US)

(72) Inventors: Kenneth Eugene Selfridge, Piedmont, SC (US); Frank Douglas Beadie, Greer, SC (US); Hua Zhang, Greer, SC (US)

(21) Appl. No.: 14/558,279

(22) Filed: Dec. 2, 2014

(51) Int. Cl. F02C 9/26; F02C 7/22

(52) U.S. Cl. CPC F02C 9/26; F02C 7/222; F05D 2220/32; F05D 2240/35

(57) ABSTRACT

A fuel purge system for a gas turbine engine includes a fuel manifold configured to receive a liquid fuel from a fuel supply and distribute the liquid fuel to a combustor assembly. Also included is a liquid pump configured to receive a liquid from a liquid supply and distribute the liquid to the fuel manifold for pressurization of the fuel manifold during a purge operation of the combustor assembly.

### BACKGROUND OF THE INVENTION

The subject matter disclosed herein relates to gas turbine engines and, more particularly, to a fuel purge system, as well as a method of purging a combustor assembly of such gas turbine engines.

During various operating conditions of a gas turbine engine, it is required that liquid fuel is inhibited from entering a liquid fuel manifold. Examples of such operations include during gas fuel operation of the gas turbine engine or during a purge credit mode of the combustor assembly. This is done to protect the liquid fuel combustor nozzles and liquid fuel mixing valves. To block the liquid fuel from entering these locations, a valve assembly is employed upstream of these components and downstream of a liquid fuel supply.

Unfortunately, due to the inherent inability of a valve to perfectly seal the pipes and based on internal pressure within these pipes, it is possible for slight leakage of the liquid fuel to pass through the valve(s) and intrude the components discussed above. Systems and methods employed to combat this problem are typically costly and complicated.

### BRIEF DESCRIPTION OF THE INVENTION

According to one aspect of the invention, a fuel purge system for a gas turbine engine includes a fuel manifold configured to receive a liquid fuel from a fuel supply and distribute the liquid fuel to a combustor assembly. Also included is a liquid pump configured to receive a liquid from a liquid supply and distribute the liquid to the fuel manifold for pressurization of the fuel manifold during a purge operation of the combustor assembly.

According to another aspect of the invention, a method of purging a gas turbine engine is provided. The method includes closing a liquid fuel valve located between a liquid fuel supply and a fuel manifold. The method also includes pressurizing the fuel manifold with a liquid from a liquid pump during a purge operation of a combustor assembly.

These and other advantages and features will become more apparent from the following description taken in conjunction with the drawings.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a schematic illustration of a gas turbine engine; and

FIG. 2 is a schematic illustration of a liquid supply system of the gas turbine engine.

The detailed description explains embodiments of the invention, together with advantages and features, by way of example with reference to the drawings.

### DETAILED DESCRIPTION OF THE INVENTION

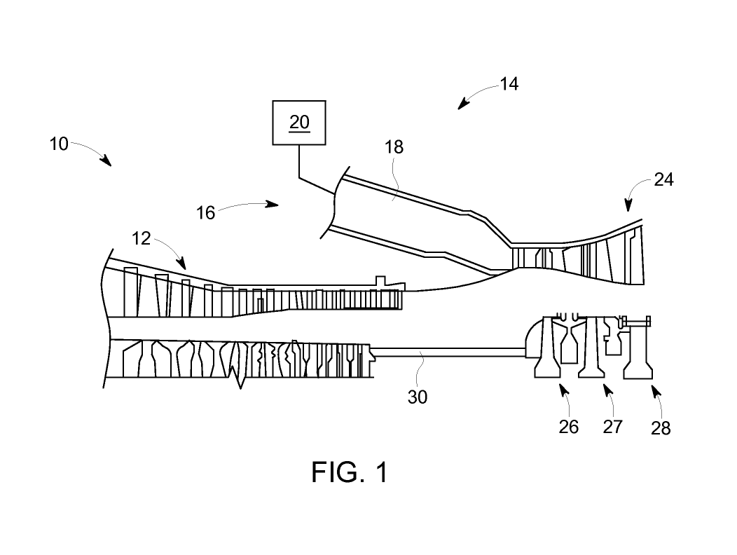

Referring to FIG. 1, a turbine system, such as a gas turbine engine 10, constructed in accordance with an exemplary embodiment of the present invention is schematically illustrated. The gas turbine engine 10 includes a compressor section 12 and a plurality of combustor assemblies arranged in a can annular array, one of which is indicated at 14. The combustor assembly is configured to receive fuel from a fuel supply system 20 through at least one fuel nozzle and a compressed air from the compressor section 12. The fuel and compressed air are passed into a combustor chamber 18 defined by a combustor liner and ignited to form a high temperature, high pressure combustion product or air stream that is used to drive a turbine 24. The turbine 24 includes a plurality of stages 26-28 that are operationally connected to the compressor 12 through a compressor/turbine shaft 30 (also referred to as a rotor).

In operation, air flows into the compressor 12 and is compressed into a high pressure gas. The high pressure gas is supplied to the combustor assembly 14 and mixed with fuel, for example natural gas, fuel oil, process gas and/or synthetic gas (syngas), in the combustor chamber 18. The fuel/air or combustible mixture ignites to form a high pressure, high temperature combustion gas stream, which is channeled to the turbine 24 and converted from thermal energy to mechanical, rotational energy. As will be appreciated from the description herein, the fuel provided is a liquid fuel, but it is to be appreciated that embodiments of the gas turbine engine 10 employ both liquid fuel and gas fuel, which may be employed during different operating conditions.

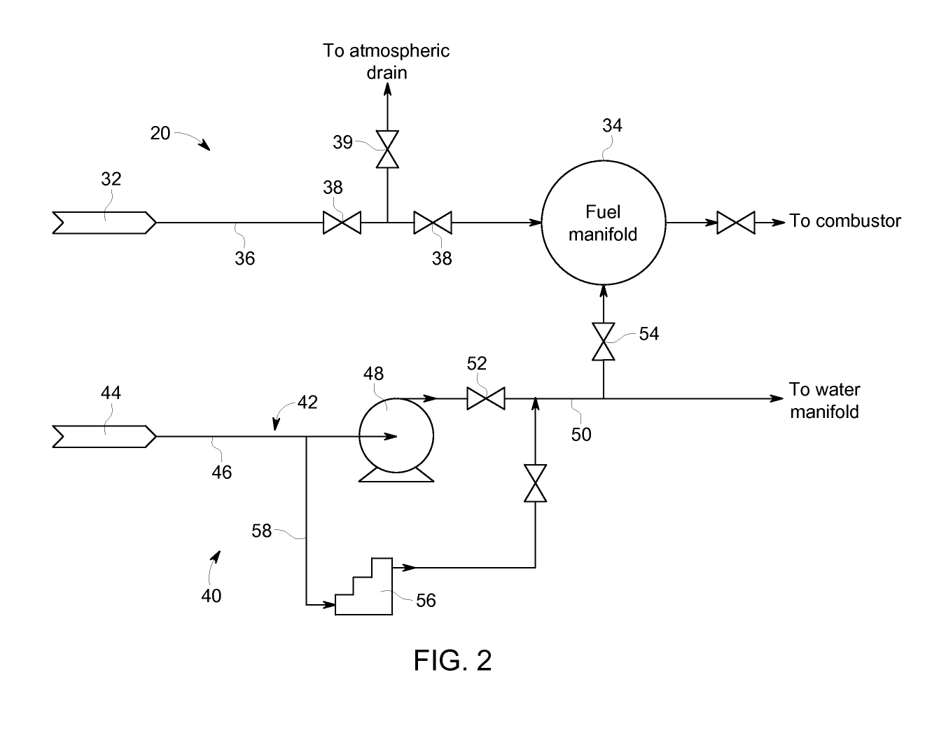

Referring now to FIG. 2, the fuel supply system 20 is illustrated in greater detail. The fuel supply system 20 includes a liquid fuel supply 32 that stores and distributes liquid fuel. The liquid fuel supply 32 is fluidly coupled to a liquid fuel manifold 34 with a liquid fuel piping arrangement 36. One or more valves 38 are included along the liquid fuel piping arrangement 36 to selectively transition between an open condition and a closed condition to control the flow rate of liquid fuel to the liquid fuel manifold 34. An atmospheric vent 39 in the form of a vent or drain is provided off of the liquid fuel piping arrangement 36. An internal pressure of the liquid fuel piping arrangement 36 is present due to the liquid fuel supply 32 being disposed at an elevated position relative to the one or more valves 38, as well as the atmospheric vent 39. Based on this internal pressure, it is possible for a leaked portion of the liquid fuel to pass through the one or more valves 38 when the valve(s) are in the closed condition.

To combat this leaked portion, pressurization of the liquid fuel manifold 34 is provided with a purge system 40. The purge system 40 is fluidly coupled to the combustor assembly 14 and is configured to purge various portions of the combustor assembly 14 with a liquid, such as water, via a water manifold. More specifically, the water is demineralized water in certain embodiments. The purge system 40 includes a liquid supply line 42 (e.g., water supply line) that is fluidly coupled to a liquid supply 44 (e.g., water supply) and a water manifold, as well as the liquid fuel manifold 34. As shown, a main portion 46 of the fluid supply line 42 is provided and routes the liquid to a liquid injection pump 48 (e.g., water injection pump) that is configured to pump the liquid to the water manifold along a liquid distribution line 50 and/or the liquid fuel manifold 34. A liquid valve 52 is provided between the liquid injection pump 48 and the liquid fuel manifold 34 to control the flow rate of liquid to the liquid fuel manifold 34. The liquid distribution line 50 includes a liquid valve 54 (e.g., water valve) that transitions between an open state and a closed state.

The liquid injection pump 48 is configured to operate at a high pressure, relative to a liquid seal pump 56 (e.g., water seal pump) that is located along a liquid line branch 58 that branches off of the main portion 46 of the fluid supply line 42. The liquid seal pump 56 is employed when the liquid injection pump 48 is not in use and is used for sealing/pressurization purposes of various portions of the fluid lines. The liquid seal pump 56 pumps liquid to the liquid fuel manifold 34 to pressurize the components therein. Pressurization opposes the leaked portion of the liquid fuel that tends to pass through the one or more valves 38, thereby reducing the likelihood of ingress of the liquid fuel to the liquid fuel manifold 34 from upstream locations along the liquid fuel piping arrangement 36.

To effectively seal the liquid fuel manifold 34 from the leaked portion of liquid fuel, the liquid pumped by the liquid seal pump 56 must exceed the internal pressure of the liquid fuel piping arrangement 36, which may vary depending upon the particular application and operating conditions. In one embodiment, the liquid seal pump 56 is configured to pump the liquid at a pressure greater than about 2 psig. In another embodiment, the pressure is greater than about 3 psig, which is greater than the internal pressure of the liquid fuel piping arrangement 36.

A method of purging the combustor assembly 14 of the gas turbine engine 10 is provided to avoid potential damage to the liquid fuel manifold 34 during a combustor assembly purging process, such as a purge credit mode. In one embodiment, the one or more valve 38 is closed to inhibit flow of the liquid fuel to the liquid fuel manifold 34 during a purge operation of the combustor assembly 14. As described above, a slight leaked portion may persist through the valve(s). The liquid fuel manifold 34 is pressurized with a liquid from the liquid seal pump 56 that operates at a low power, yet providing a pumped liquid that is greater than the internal pressure of the liquid fuel piping arrangement 36. By employing a low power pump integrated in the fuel supply system 20, cost-effective and efficient protection of the liquid fuel manifold 34 is achieved.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. A fuel purge system for a gas turbine engine comprising:
a fuel manifold configured to receive a liquid fuel from a fuel supply and distribute the liquid fuel to a combustor assembly; and
a liquid pump configured to receive a liquid from a liquid supply and distribute the liquid to the fuel manifold for pressurization of the fuel manifold during a purge operation of the combustor assembly.

2. The fuel purge system of claim 1, wherein the liquid comprises water.

3. The fuel purge system of claim 2, wherein the liquid comprises demineralized water.

4. The fuel purge system of claim 2, further comprising a water injection pump configured to receive water from the liquid supply and distribute the water to a water manifold along a water distribution line during an open state of a water valve located between the water injection pump and the water manifold.

5. The fuel purge system of claim 4, wherein the liquid pump comprises a water seal pump configured to pump water during a closed state of the water valve.

6. The fuel purge system of claim 1, wherein the liquid is pumped at a pressure of at least 2 psig.

7. The fuel purge system of claim 1, wherein the liquid is pumped at a pressure of at least 3 psig.

8. The fuel purge system of claim 1, further comprising a liquid fuel valve disposed between the fuel supply and the fuel manifold, wherein the liquid is distributed to the fuel manifold during a closed condition of the liquid fuel valve to reduce a leaked portion of the liquid fuel from entering the fuel manifold.

9. A method of purging a gas turbine engine comprising:
closing a liquid fuel valve located between a liquid fuel supply and a fuel manifold; and
pressurizing the fuel manifold with a liquid from a liquid pump during a purge operation of a combustor assembly.

10. The method of claim 9, wherein the liquid comprises water.

11. The method of claim 10, wherein the liquid comprises demineralized water.

12. The method of claim 10, further comprising pumping the water at a pressure of at least 2 psig.

13. The method of claim 10, further comprising pumping the water at a pressure of at least 3 psig.

14. The method of claim 10, further comprising closing a water injection pump configured to receive water from a water supply and distribute water to a water manifold.

15. The method of claim 14, wherein the liquid pumped by the liquid pump is separated into a first stream and a second stream, the first stream routed to the fuel manifold, the second stream routed to the water manifold.

16. The method of claim 10, wherein a leaked portion of a liquid fuel passes through the liquid fuel valve, wherein pressurizing the fuel manifold with the water reduces an amount of the leaked portion that infiltrates the fuel manifold during the purge operation.

17. The method of claim 16, wherein the water is pumped at a pressure greater than a pressure in a liquid fuel line located upstream of the fuel manifold.
